(19) United States
(12) Patent Application Publication
(10) Pub. No.: US 2011/0246156 A1
(43) Pub. Date: Oct. 6, 2011

(54) Method for Determining the Probability of a Collision of a Vehicle With a Living Being

(75) Inventors: Stephan Zecha, Hoesbach (DE); Woldemar Bauer, Aschaffenburg (DE)

(73) Assignee: CONTINENTAL SAFETY ENGINEERING INTERNATIONAL GMBH, Alzenau (DE)

(21) Appl. No.: 13/132,906

(22) PCT Filed: Dec. 15, 2009
(86) PCT No.: PCT/DE2009/001750

§ 371 Date: Jun. 3, 2011

(30) Foreign Application Priority Data
Dec. 23, 2008 (DE) 10 2008 062 916.2

(51) Int. Cl. G08G 1/16; G06G 7/48

(52) U.S. Cl. 703/6

(57) ABSTRACT

The invention describes a method for determining the probability of a collision of a vehicle with a living being, in which the behaviour in space and time of the living being is modelled by means of a behavioural model and the behaviour in space and time of the vehicle is modelled by means of a kinematic model and, starting from the current positions of the vehicle and the living being, at least one trajectory for each of them is determined. According to the invention, the current positions of the living being and of the vehicle are used to compute trajectories of the vehicle and of the living being as a trajectory pair until said trajectory pair either indicates a collision or indicates no collision, whereupon the number of trajectory pairs indicating a collision is determined, and the probability of a collision is determined as the quotient of the number of trajectory pairs indicating a collision and the total number of trajectory pairs that have been computed.

The invention relates to a method for determining the probability of a collision of a vehicle with a living being, in particular a pedestrian, according to the preamble of patent claim 1, in particular for use in a person protection system in a vehicle or a driving simulator.

In such a method, surroundings information is obtained by means of at least one sensing system. Said surroundings information is evaluated by a computing unit in order to identify a living being. Furthermore, a movement trajectory and a state of motion are determined for the living being on the basis of a behavioural model of said living being at a certain moment in time in order to assess the probability of a collision, for example of a pedestrian with the vehicle.

A high risk of a collision, i.e. a high probability of a collision, can lead to various actions to protect the pedestrian. For example, a warning can be issued to the driver and/or the pedestrian, a pedestrian protection device can be activated, or autonomous vehicle actions, such as for example an emergency braking or an emergency steering manoeuvre, can be carried out.

In order to detect the risk of a collision between motor vehicles and pedestrians, cyclists or animals (in general living beings) in road traffic and to initiate appropriate protective measures if the probability of a collision is high, relevant traffic situations must be recorded and evaluated. This information can be used to determine a state of motion of the vehicle on the one hand and a state of motion of the living being that is observed on the other. The further movement behaviour of the two road users is determined by extrapolation.

To identify collision situations and to differentiate correctly between critical and non-critical situations, high-quality methods to calculate the existing risk must be used.

For example, it is known to perform a risk assessment exclusively on the basis of a statistical analysis of the error variances of the positions of the pedestrian that have been determined, or as an alternative, to base the calculation on the assumption of a one-dimensional transverse distribution of the areas occupied by the vehicle and the pedestrian and to use the mathematical operation of convolution of the two transverse distributions.

The ability to predict the movement behaviour of the living being is also crucial for the reliability of the collision risk assessment. The more precise said prediction ability is, the better protection systems which are adapted to the situation can be selected and activated. In particular, this also serves to avoid false activations which do not contribute to protecting the road users but rather increase the maintenance costs of the vehicle or confuse the driver or cause secondary damage in the case of false warnings.

DE 103 25 762 A1 describes a method for operating an image processing system for a vehicle. In said method, surroundings information is obtained by means of at least one image sensor and evaluated by a computing unit in order to detect the presence of road users. Among other parameters, the gaze direction of one or several road users that have been identified is detected. The risk of a collision is assessed taking into account the attentiveness of the road users. The gaze direction of one or several road users serves as an indicator of attentiveness. This is based on the consideration that the gaze direction of a road user indicates whether said road user is attentive and e.g. notices an approaching vehicle. The risk of a collision is assessed to be higher if the road user gazes in a direction facing away from the image sensor and to be smaller if said road user gazes directly into the image sensor. In addition, it is intended to create a probability scale for collision risk assessment, based on the detection and evaluation of the gaze directions of road users that have been identified. This is done using motion information of the vehicle and/or of the road user(s) that have been detected.

Said motion information includes the speed, direction and trajectory of movement of a vehicle and/or a road user that has been identified.

In addition, EP 1 331 621 B1 discloses a method for monitoring the surroundings of motor vehicles with regard to the risk character of a potential obstacle, wherein the uncertainty of position measurements as well as the uncertainties in respect of the future behaviour of the object are taken into account, in particular including special and sudden events which are liable to change the future behaviour of said object. To determine the probability of a collision, the maximum area which can be reached by the object is determined at subsequent moments in time. The result is a trajectory path which becomes wider and wider in the direction of future moments in time. The probability of a collision at a particular moment in time is then determined by the percentage overlap of the areas defined by the potential positions of the vehicle and of the object at this moment in time. If said areas do not overlap, the probability of a collision is zero; if there is a complete overlap, said probability is 100%. The drawback of this known method is that the future behaviour of the object is based on a behavioural model which only includes kinematic parameters, such as direction, speed and acceleration, and extrapolates them into the future.

It is therefore the object of the present invention to avoid the drawbacks of the state of the art and to provide a method for determining the probability of a collision of a vehicle with a living being.

The aforesaid object is achieved by means of a method having the features of claim 1. Advantageous further developments are set forth in the dependent patent claims.

In the method according to the invention for determining the probability of a collision, the current positions of the living being and of the vehicle are used to compute trajectories of the vehicle, based on the kinematic model, and of the living being, based on the behavioural model, as a trajectory pair until said trajectory pair either indicates a collision or indicates no collision. Subsequently, the number of trajectory pairs indicating a collision is determined and used to compute the probability of a collision as the quotient of the number of trajectory pairs indicating a collision and the total number of trajectory pairs that have been computed.

In this way, the probability of a collision, hereinafter also referred to as collision risk value, is computed as a relative collision frequency, i.e. as a ratio of the number of vehicle/living being trajectory pairs where a collision would occur to the total number of potential vehicle/living being trajectory pairs that have been computed.

In a further development of the invention, a collision is indicated if the distance between the vehicle and the living being which is indicated by the trajectories of a trajectory pair is below a predefined threshold. Such a distance threshold is preferably adapted to the dimensions of human beings; for example, the radius of the circumcircle around the contour of a pedestrian as seen from above would be suitable for this purpose.

It is particularly advantageous if the method steps of

b) using the current positions of the vehicle and of the living being to compute trajectories of the vehicle and of the living being as a trajectory pair until said trajectory pair either indicates a collision or no collision is indicated,
c) determining the number of trajectory pairs indicating a collision, and
d) computing the probability of a collision as the quotient of the number of trajectory pairs indicating a collision and the total number of trajectory pairs that have been computed are repeated at time increments.

This shows the development of the risk of a collision during the course of the scenario between the vehicle and the living being or the pedestrian over time, so that the chronological development of the probability of a collision or of the collision risk value is obtained as a result. Said collision risk value can be used to activate pedestrian protection systems if it exceeds a predefined threshold, wherein said activation may in addition be dependent on the development of the collision risk value.

In a further development of the invention, the behavioural model is used to determine potential positions of the living being at one or several moments in time, taking into account the state of motion at the time when the computation of a trajectory pair starts.

To determine the potential future position at a given moment in time, the behavioural model for the behaviour of the living being in space and time is applied to a place of the movement trajectory and the state of motion, thus determining potential positions at one or several future moments in time.

Moreover, in a particularly preferred further development of the invention, the computation of the trajectories of the living being is based on a behavioural model which takes into account the physical and physiological movement ability of the living being and/or behavioural patterns that have been determined empirically, i.e. it is assumed that the living being, due to his/her physiology, cannot move in all directions with the same acceleration ability and, in addition, may have certain preferred directions due to his/her general behaviour. In contrast to conventional trajectory algorithms, the method does not project the current mode of movement into the future, but uses it as a basis while taking into account a limited physiological movement ability and/or preferred movements which are due to the general behaviour of the living being. In addition, living beings or pedestrians differ from the other usual objects in road traffic in that they are able to make sudden changes in direction by rotating about their own axis, by sideways or backward steps, thus changing the position of the living being dramatically compared to conventional trajectory predictions, as has been found in various motion studies.

In the description below, “living being” means a cyclist, a pedestrian or an animal. A “position” of the living being is understood as an area where said living being will very probably be located at a future or next moment in time (with a probability of more than 50%, in particular more than 70%, and even more preferred more than 90%).

The recording of surroundings information by means of sensors, for example using imaging methods, serves to determine a movement trajectory on the one hand and a state of motion of the living being on the other. If both these pieces of information are then combined with the physiological movement ability of the living being, which takes into account biomechanical facts and/or behaviour-specific preferred directions of the living being that has been detected, potential positions at one or several future moments in time can be determined with greater accuracy. This information can then be used to compute the probability of a collision.

The sensing system used to obtain the surroundings information can comprise for example radar, LiDAR, cameras, ultrasonic sensors, or be constituted or supported by communication technologies, such as e.g. RFID (RFID=Radio Frequency Identification) or GPS (GPS=Global Positioning System).

One or several of the parameters below are determined and processed as parameters for the determination of the state of motion and/or of the potential future position:
A position of the living being. This means in particular a relative position of the living being to the vehicle. The criterion can also be a distance or a relative position of said living being from or to a path of movement of the vehicle that has been determined.
An orientation of the living being relative to the surroundings. This means in particular the angle at which the living being is positioned relative to the surroundings, in particular to the vehicle or a road. Due to the physiological movement ability of the living being, the orientation of said living being relative to the surroundings, e.g. positioned with his/her back to the road or the vehicle or walking with his/her side to the road or the vehicle, is of great importance for the potential future position.
A translational and/or rotational speed of the living being. The physiological movement ability and hence the potential future position depend on the speed of the living being, i.e. on how fast said living being moves.
A translational and/or rotational acceleration of the living being, which, due to the physiological movement ability of said living being, determines the maximum speed that can be achieved by said living being and/or the further acceleration ability.
A current radius of curvature of the movement made by the living being and/or a change in a direction of movement or of a radius of curvature of the movement of the living being. This parameter to be taken into account is based on the consideration that a living being that is moving in a curve has a limited capability to change his/her direction of movement and/or speed and/or acceleration, compared to a living being that walks in a straight line.
A ground friction coefficient of the road surface, which in particular depends on the weather and can be scaled, e.g. if said surface is found to be wet. The ground friction coefficient is of decisive importance for the acceleration ability of the living being.
A class the living being belongs to, in particular the age of the living being, a predefined body dimension (e.g. height, leg length or inside leg length), a gender or a category (e.g. human being/animal/child/cyclist).
An ability to move by means of one or several sideways steps.
An ability to move by means of one or several backward steps.
An ability to move by moving the centre of gravity and/or by inclining the body of the living being or the pedestrian, which can be used to deduce a specific movement behaviour, in particular if it is analysed in conjunction with motion patterns that have been determined empirically.

In fact, the unique ability of living beings to rotate about their own axis, to step sideways or, at least from a standstill position, to walk abruptly backwards, i.e. to move opposite to the current orientation of the body, as well as a limited and varied physiological movement ability in all directions will lead to results that differ significantly from those of conventional trajectory algorithms when predicting a probable position.

The above parameters can for example be determined by evaluating image information and/or location information.

The term “state of motion” of a living being or of a pedestrian also includes a change in movement of said living being or pedestrian. In this context, those parameters which indicate an imminent change in movement of the living being or pedestrian are of particular importance.

While certain parameters, such as the position, orientation, translational speed and acceleration or the curve radius are also detected and taken into account for conventional trajectory algorithms, the present method is different in that the probable position is always predicted taking into account the physiological movement ability and/or preferred directions which are due to the general behaviour of the living being, i.e. it is not assumed that the current state of motion continues unchanged, but it is taken into account and the prediction is limited to what is physiologically possible and/or will probably happen due to general behaviour.

In another further development, a potential future position corresponding to the parameters that have been determined is retrieved from a database or a family of characteristics; for this purpose, the measured parameters are for example compared with the parameters that are stored in the database or the family of characteristics. The parameters on which the database or family of characteristics is based can for example be determined by means of experiments.

As an alternative, one or several of the parameters are supplied to a model computer in order to determine the position of the living being, wherein said model computer is based on an abstract movement model for living beings. The measured parameters are supplied to the model computer, which is able to determine the potential future position using said movement model for living beings. This approach has the advantage that different classes of living beings can be taken into account in a simplified manner by appropriately scaling individual parameters, so that they are taken into account more or less intensively. Another advantage is that the potential future position can be determined on the basis of physical facts and empirical data. In this way, a very high accuracy of the prediction can be achieved.

According to another further development, the current speed, the current orientation and the current rotation of the body are used to determine a path of movement in order to determine the potential future position.

In another further development, the maximum acceleration ability of the living being, which is dependent on his/her speed of movement, is taken into account for the determination of the potential future position. This is based on the consideration that the acceleration ability of a living being is not constant, but varies over the speed range covered by said living being. The same is true for the deceleration ability of a living being. It has also been found that the deceleration ability of a living being exceeds its acceleration ability. This finding can advantageously be used when determining the potential future position. In addition to a maximum acceleration ability in the current direction of movement, a maximum acceleration ability opposite to the current direction of movement and/or orientation of the living being is preferably predefined.

Therefore, at least one of the parameters below is preferably predefined for the living being:
a maximum speed from which the acceleration ability in the current direction of movement is zero, i.e. the absolute maximum speed,
a maximum acceleration in the direction of orientation of a non-moving living being as well as opposite to said orientation,
a speed at which the maximum acceleration ability in the current direction of movement is highest,
a speed at which the maximum acceleration ability opposite to the current direction of movement and/or orientation of the living being is highest in value, i.e. at which the living being is able to slow down fastest,
a maximum speed opposite to the orientation of the living being from which the acceleration ability opposite to said orientation is zero. In conjunction with a current form of movement, these values can then be used to determine the relevant acceleration ability in the direction of movement and in the opposite direction, i.e. the ability to slow down. As an alternative, relevant characteristic curves can of course be stored.

These values are preferably predefined as a function of the class of living being concerned, in particular varying according to age, gender and body dimensions.

In another further development, a minimum possible curve radius, which is dependent on the current walking speed and/or acceleration, is taken into account for the determination of the potential future position. Knowledge of a minimum possible curve radius makes it possible to predict how fast a living being can change his/her direction, for example to cross a road or to cross the path of movement of the vehicle.

According to another further development, a maximum deceleration ability, which is dependent on the speed of movement and/or a curve radius of the movement made by the living being, is taken into account for the determination of the potential future position. This information can for example be used to take into account whether a living being that may potentially collide with the vehicle is able to stop early enough before reaching a collision zone or to move away from said collision zone.

According to another further development, an angle at which the living being is positioned or moves relative to a path of travel of the vehicle is taken into account for the determination of the potential future position, wherein said angle is used to determine the amount of time it takes the living being to turn towards the path of travel while accelerating substantially at the same time in order to reach the travel path area. Knowledge of said angle as well as of the amount of time required by the living being, for example to reach the road, enable a more precise estimate of a potential future position and hence an improved assessment of the risk of a collision.

The angle taken into account is an angle ranging between 150° and 210°, corresponding to a living being that is positioned or moves with his/her back to the path of travel. As an alternative, the angle taken into account in particular ranges between 60° and 120°, corresponding to a living being that is positioned or moves with his/her side to the path of travel. Said path of travel may coincide with the course of a road in this case.

The potential future position is determined taking into account a relative position of the living being to the path of travel, in particular a distance at which the living being is positioned or moves relative to said path of travel, wherein said relative position is used to determine the amount of time it takes the living being to accelerate in order to reach the travel path area.

Furthermore, it is intended that surroundings information and/or obstacles be taken into account for the determination of the potential future position. This information can for example be obtained by means of digital maps or by the surroundings sensing system. The accuracy of prediction of the potential future position can be further increased if obstacles, e.g. a course of the road, the presence of house walls and the like, are taken into account.

The position of the living being thus determined serves as an input variable for the computation of the trajectory of a trajectory pair which is to be suitable for the computation of the probability of a collision.

In another further development, the position is divided into several sub-positions having different probabilities. In other words this means that probabilities are specified for individual sub-positions of a potential future position that has been determined, wherein “probability” means the probability that the living being will be located at said sub-position within the next milliseconds or seconds, in accordance with the position measured over time (movement).

Said probabilities can be used to determine the progressive partial trajectories of a pedestrian included in a trajectory pair, which are required to compute the probability of a collision.

The invention also relates to a vehicle comprising a protection system for living beings, preferably for pedestrians outside said vehicle, in particular pedestrian protection devices which, in order to implement the method, are equipped
with at least one sensing system to obtain surroundings information,
with a computing unit which evaluates said surroundings information in order to identify a living being, in particular a pedestrian, determines movement trajectories for the living being and the vehicle as a trajectory pair, and uses said trajectory pair to deduce the probability a of collision and hence the necessity to activate a protection system, wherein
in particular, the sensing system is designed to detect parameters of living beings and of their physiological movement ability, and
the computing unit is designed to determine the potential future position at a given moment in time, based on a location of the movement trajectory and on the state of motion and taking into account a physiological movement ability of the living being at one or several future moments in time.

The probabilities of a collision for collision situations between the pedestrian and the vehicle can advantageously be computed by means of the computing method described below.

The method according to the invention preferably comprises the following method steps:
1. During the initial phase, before the vehicle is put into operation, a finite number of typical initial situations of motion (initial state of motion) for different types of pedestrians are measured and stored in a memory which is located aboard the vehicle. This initial situation can be defined as follows:
   Initial situation 1: pedestrian does not move, speed: v=0 m/s, acceleration a=0 m/s², rate of rotation: w=0°/s;
   Initial situation 2: an adult pedestrian walks at a speed of v=1 m/s, acceleration a=0 m/s², rate of rotation w=0°/s;
   Initial situation 2: an adult pedestrian walks at a speed of v=1 m/s, acceleration a=0 m/s² while rotating about his/her vertical axis at a rate of rotation w=1°/s; . . . .
2. For each of the initial situations of step 1, a group of potential movement trajectories for a predefined period of time of e.g. 3 s comprising increments Δt of e.g. 0.1 s is computed. For this purpose, the computation method of stochastically modelling the pedestrian is used. A group of trajectories including the intermediate position points of the pedestrian is obtained as a result of these numerical computations for each initial situation of motion.
3. The initial situations of motion and the trajectory groups that have been computed are stored in the memory aboard the vehicle.
4. Next, the risk of a collision during operation of the vehicle is computed as follows:
   4.1. The state of motion of the pedestrian is detected by means of a suitable sensor system. In addition, the vehicle's own dynamics are detected at the same moment in time.
   4.2. The nearest initial situation of motion of the pedestrian, which was measured and stored in the memory during the initial phase in step 1, is selected.
   4.3. The trajectory group which was computed for the selected initial situation of motion in step 2 of the initial phase and stored with reference to said initial situation of motion is retrieved and placed around the position of the pedestrian that has been detected, in accordance with the orientation of said pedestrian.
   4.4. The information obtained in 4.1 to 4.3 is used to compute the risk of a collision as follows:
      a. The travel of the vehicle is extrapolated at small time increments. Said time increments correspond to the time increments used for the computation of the trajectory group of the pedestrian: Δt of e.g. 0.1 s. In this way a driving path is obtained, wherein said driving path comprises areas for each of said time increments. These areas are areas where a collision of a pedestrian with the vehicle cannot be avoided. Said areas will hereinafter be referred to as collision zone.
      b. At each time increment Δt, only the position points of the trajectories of the trajectory group selected in step 4.3 are analyzed, wherein said position points at a particular time increment reflect the potential positions of the pedestrian at the time increment concerned. Next, it will be checked if any or how many of the selected position points are located within the collision zone of the vehicle. If this is the case, there will be a single collision between the vehicle and the pedestrian. The number of trajectories contained in the trajectory group including the position points which predict a single collision is determined.
      c. Those trajectories where collisions have occurred are disregarded in the subsequent computation steps for the next time increments.
      d. Steps b and c are repeated at time increments Δt in order to determine the number of single collisions for the subsequent time increments.
      e. Steps a to d are continued to be carried out until the vehicle has passed the pedestrian to an extent that no further collisions may occur.
   4.5. In this way, the number of trajectories including at least one position point which is located in any of the collision zones of the vehicle is determined, and the quotient of the number of collision trajectories and the total number of trajectories is computed. This quotient is an indicator of the probability of a collision. Said quotient can therefore be used to determine the risk of a collision.
   4.6. As an option, the aforesaid quotient is compared with a number of predefined thresholds. If the quotient is below a first, lowest threshold, there is no risk of a collision. If the quotient exceeds the first threshold, but is below a second, second-lowest threshold, there is a small risk of a collision. This small risk of a collision can e.g. be eliminated by means of an alarm signal to the driver of the vehicle. If, however, the quotient exceeds a last, highest threshold, there is an imminent risk of a collision between the vehicle and the pedestrian. In this case, measures to reduce the consequences of the accident, e.g. autonomous full braking of the vehicle, are required.
5. The determination of the probability of a collision according to step 4 can be repeated iteratively at defined time intervals, e.g. of 0.5 s. In addition, the travel of the vehicle can also be varied in another computation loop using a stochastic model.

In more detail, during the initial phase, before the vehicle is put into operation, a finite number of typical initial situations of motion Px-BS1(v1, a1, w1), Px-BS2(v2, a2, w2), Px-BSn(vn, an, wn) for a model pedestrian Px is predefined, taking into account the movement ability of said pedestrian. Here, v1, v2, . . . , vn are different initial speeds, a1, a2, . . . , an are different initial accelerations, and w1, w2, . . . , wn are different initial rates of rotation of the model pedestrian Px.

A group of potential movement trajectories BT-Px-BS1, BT-Px-BS2, . . . , BT-Px-BSn is computed for each of these initial situations of motion Px-BS1(v1, a1, w1), Px-BS2(v2, a2, w2), . . . , Px-BSn(vn, an, wn) for a predefined period of time (e.g. 3 s) comprising increments Δt (e.g. of 0.1 s). The computation method used includes stochastic modelling of the pedestrian. A group of trajectories including the intermediate position points of the model pedestrian Px is obtained as a result of these numerical computations for each initial situation of motion. Said model pedestrian Px can for example represent 90% of all adult men.

Further initial situations of motion are defined for other groups of pedestrians, such as adult women, elderly pedestrians, children, as well as for cyclists or animals such as dogs, and relevant groups of movement trajectories are determined.

Said initial situations of motion and the associated trajectory groups that have been determined are stored in an internal memory of the vehicle for later use.

During operation of the vehicle or while driving through a city centre, first the pedestrians in the proximity of the vehicle, in particular in the area of or near the driving path of the vehicle, are detected by means of the surroundings sensing system which is located aboard the vehicle.

In addition, the states of motion of the detected pedestrians are detected by means of suitable sensors, e.g. in the form of speed, acceleration and rate of rotation values v0, a0, w0, . . . . These states of motion are used as initial situations of motion for the determination of the risk of a collision. The states of motion vx, ax, wx of pedestrians detected earlier are preferably continued to be detected.

At the same time, the vehicle's own dynamics, i.e. its speed, acceleration and/or rate of rotation, are detected. The travel of the vehicle is extrapolated at small time increments, based on the measured values relating to the vehicle's own dynamics. Said time increments correspond to those used to compute the trajectory group of the pedestrian during the initial phase, i.e. Lt. In this way, a driving path is obtained, wherein said driving path comprises areas for each time increment. These areas are the collision zones at each of said time increments.

If a pedestrian P0 is detected, the state of motion values v0, a0, w0, . . . of said pedestrian P0 are compared with the typical initial situation of motion values Px-BS1(v1, a1, w1), Px-BS2(v2, a2, w2), . . . Px-BSi(vi, ai, wi), . . . , PxBSn(vn, an, wn) which were measured and stored during the initial phase.

As an option, the type of the pedestrian P0 is determined before the state of motion values are compared, i.e. the data measured for this pedestrian P0 by means of the surroundings sensing system is used to decide which group of pedestrians said pedestrian P0 should belong to. If the data measured by the surroundings sensing system comprises characteristic features of an adult male pedestrian, the newly detected pedestrian P0 is categorized as belonging to the group of “adult men”. If, however, the data measured by the surroundings sensing system comprise characteristic features of a child, the pedestrian P0 is categorized as belonging to the group of “children”. This allocation to a group facilitates the retrieval of the relevant initial situation of motion values from the memory from among the numerous initial situation of motion values which were measured and stored during the initial phase.

If the newly detected pedestrian P0 is categorized as belonging to the group of “adult men”, only those initial situation of motion values Px-BS1(v1, a1, w1), Px-BS2(v2, a2, w2), . . . , Px-BSi(vi, ai, wi), . . . , Px-BSn(vn, an, wn) which were stored with reference to the group of “adult men” are retrieved and used for a comparison with the state of motion values v0, a0, w0.

If the state of motion values v0, a0, w0, . . . of the pedestrian P0 are most similar to a set of initial situation of motion values, e.g. Px-BSi(vi, ai, wi), the group of movement trajectories BT-Px-BSi which was stored with reference to this set of initial situation of motion values Px-BSi(vi, ai, wi) is used to determine a collision.

The selected group of movement trajectories BT-Px-BSi belonging to the aforesaid initial situation of motion values PxBSi(vi, ai, wi) is placed around the detected position of the pedestrian P0 in a suitable orientation, wherein said orientation is preferably the orientation of the pedestrian P0 relative to the direction of magnetic north and wherein the starting point of the group of movement trajectories preferably overlaps the centre point of said pedestrian P0.

The position points of the trajectories of the selected trajectory group are used to determine the risk of a collision at each of the aforesaid time increments Δt, wherein said position points at each time increment reflect the potential positions of the pedestrian at the time increment concerned.

Next, it will be checked how many of these selected position points are located within the relevant collision zone of the vehicle. Each of the position points located within the collision zone indicates a single collision between the vehicle and the pedestrian. The number of trajectories contained in the trajectory group including the position points which predict a single collision is determined. The trajectories including said collision position points are disregarded in the subsequent computation steps for the following time increments.

The position points which are located within the collision zone and the number of trajectories including these position points are continued to be determined at time increments of Δt until the vehicle has passed the pedestrian to an extent that no further collisions may occur.

Subsequently, the number of all (collision) trajectories where at least one position point is located within the collision zones is determined, and the quotient of the number of collision trajectories and the total number of trajectories is computed. This quotient indicates the probability of a collision. Said quotient can therefore be used to determine the risk of a collision.

Advantageously, the aforesaid quotient is compared with a number of predefined thresholds. If the quotient is below a first, lowest threshold, there is no risk of a collision. If the quotient exceeds the first threshold, but is still below a second, second-lowest threshold, there is a small risk of a collision. This small risk of a collision can e.g. be eliminated by means of an alarm signal to the driver of the vehicle. If, however, the quotient exceeds a last, highest threshold, there is an imminent risk of a collision between the vehicle and the pedestrian. In this case, measures to reduce the consequences of the accident, e.g. autonomous full braking of the vehicle, are required.

The method for computing the risk of a collision described above requires much less computing time and enables the probability of a collision to be computed almost in real time.

By means of the computation method described above, the risk of a collision can be computed in the required real time when a collision situation arises.

The invention will now be explained with reference to the drawings, in which:

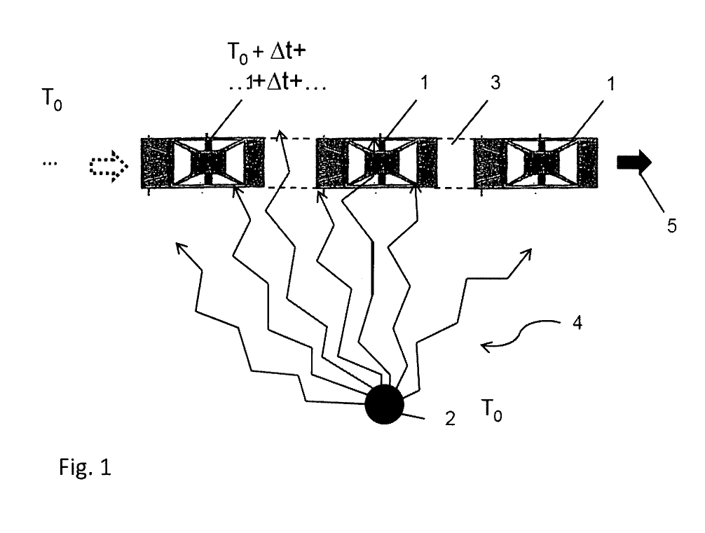

FIG. 1 shows a schematic view of a scene including a vehicle and a pedestrian, which is intended to explain the method according to the invention,

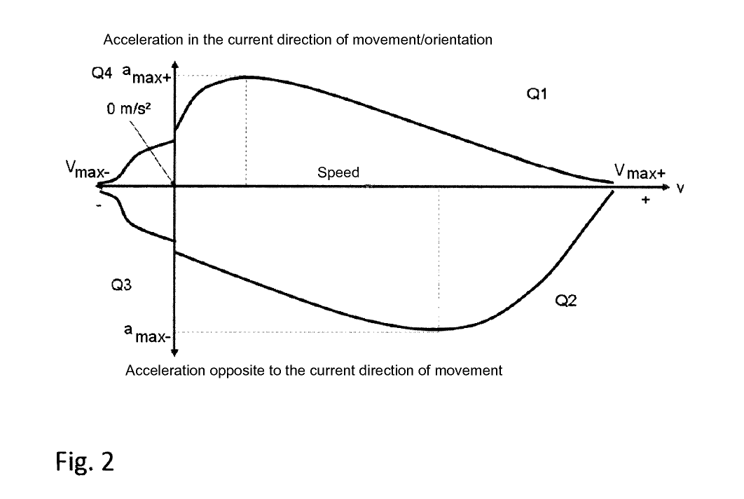

FIG. 2 shows a diagram which illustrates the interrelationship between the lateral acceleration and deceleration abilities of a living being as a function of a speed reached by said living being,

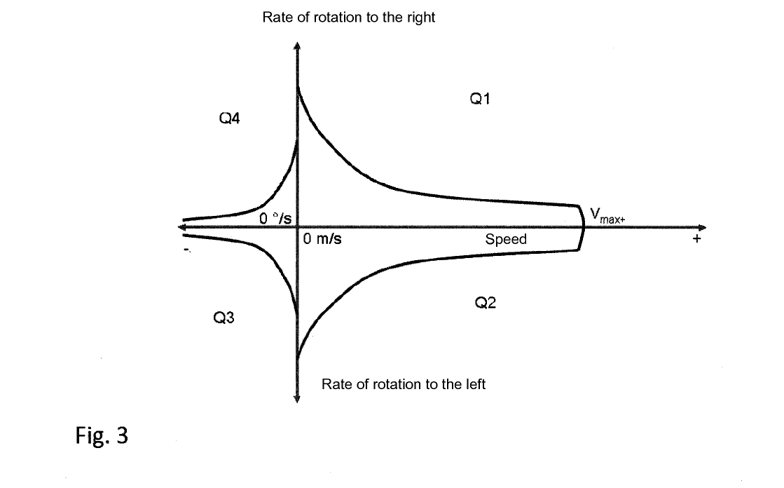

FIG. 3 shows a diagram which illustrates the interrelationship between the rotation ability of a living being as a function of a lateral speed reached by said living being,

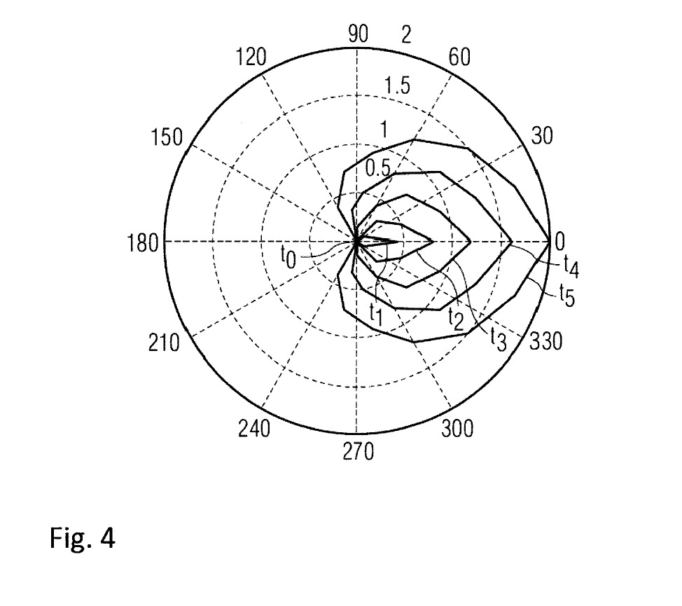

FIG. 4 shows a polar diagram which illustrates the range of motion of a human being from a standstill position, taking into account the lateral acceleration ability and the rotation ability,

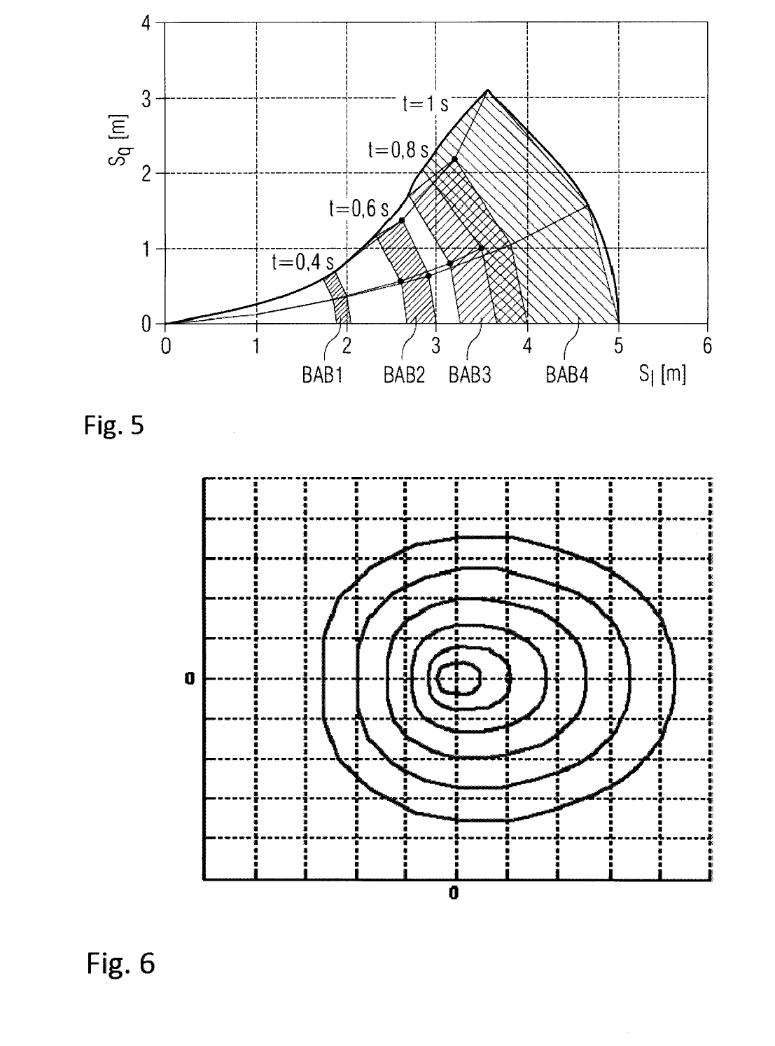

FIG. 5 shows a polar diagram which illustrates the range of motion of a human being from a standstill position, taking into account the lateral acceleration ability, the rotation ability as well as the ability to move sideways and backward,

FIG. 6 shows a diagram which illustrates the range of motion in the longitudinal and transverse directions of a human being that moves at a certain speed,

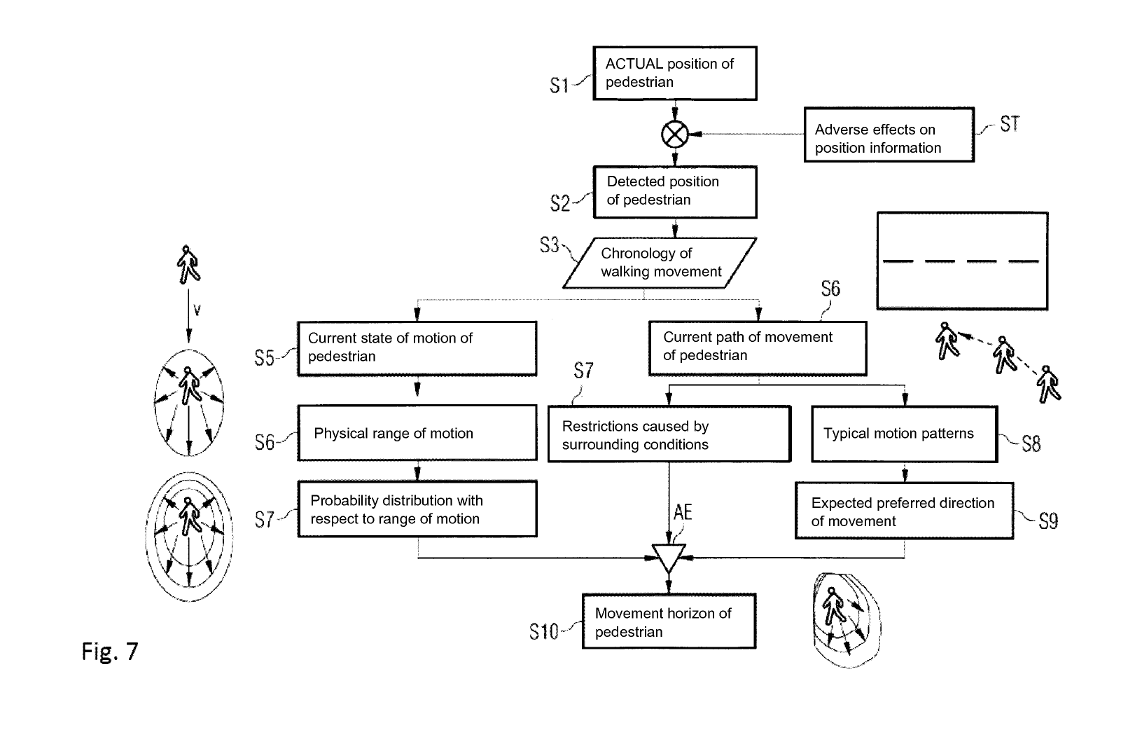

FIG. 7 shows a flow chart which illustrates the method for determining the trajectory of a pedestrian,

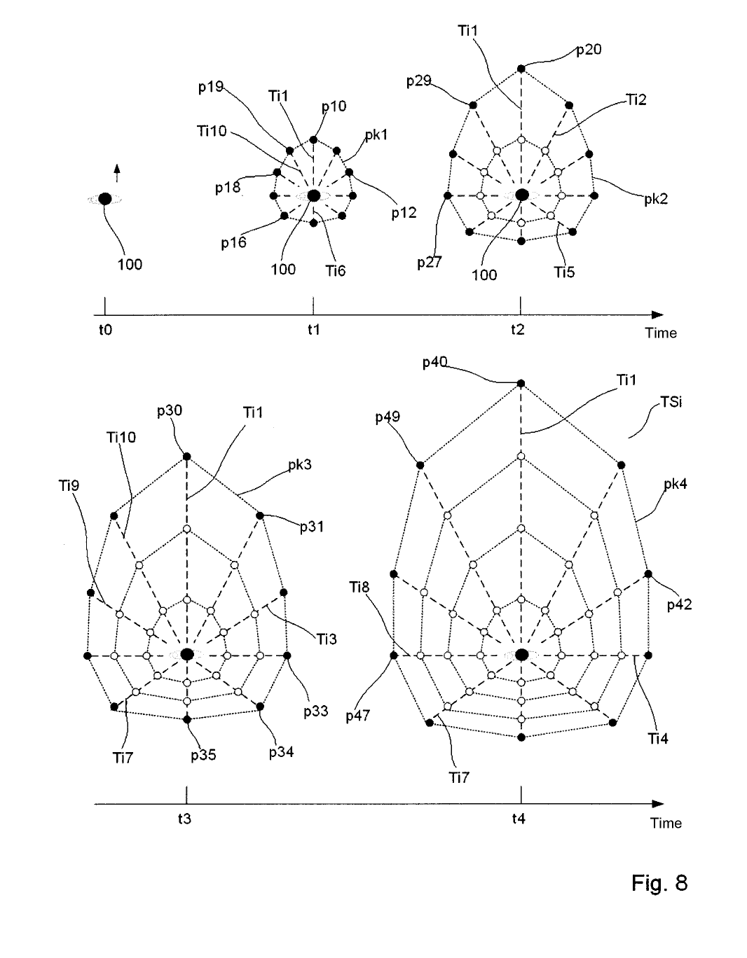

FIG. 8 shows a schematic view which illustrates the determination of trajectory groups for a finite number of typical initial situations of motion for different types of pedestrians during the initial phase, and

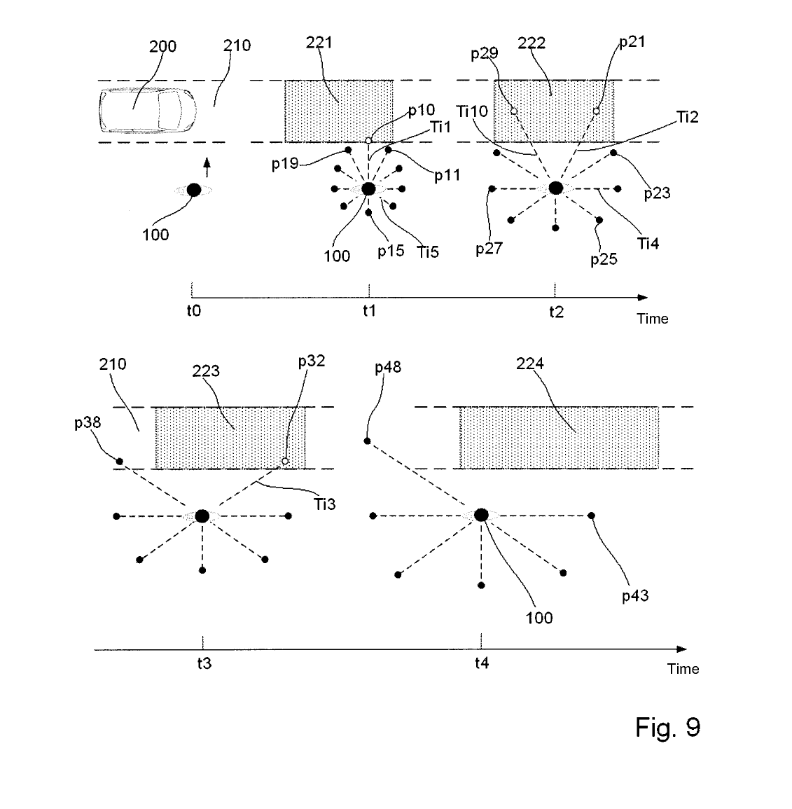

FIG. 9 shows a schematic view which illustrates the determination of the probability of a collision according to the invention.

To determine the probability of a collision between a vehicle and a living being, in particular a pedestrian, cyclist or animal, a reliable prediction of the path of movement of a vehicle (so-called driving path) on the one hand and of the path of movement (so-called trajectory) of the living being on the other is required. While the driving path of a vehicle can already be determined with high precision on the basis of a kinematic model, the determination of the path of movement of the living being is subject to a plurality of elements of uncertainty which must be taken into account in a behavioural model describing the behaviour in space and time.

FIG. 1 schematically shows a scene including a vehicle 1 and a pedestrian 2, wherein the vehicle 1 moves in the direction of the arrow 5.

The method according to the invention for computing the probability of a collision starts from the current positions and states of motion of the vehicle 1 and the pedestrian 2 at a moment in time T₀.

These positions are used to determine the further paths of movement for the vehicle 1, using a kinematic model, and for the pedestrian 2, using a behavioural model, on the basis of time increments Δt's, wherein each Δt is a prediction period. In this way, progressive trajectories over the subsequent prediction periods Δt's can simultaneously be determined for the vehicle 1 and for the pedestrian 2 as a trajectory pair, wherein each trajectory is composed of partial trajectories which have been determined for the prediction period Δt. Since various movement options will be obtained for the pedestrian for each prediction period Δt, which as a rule is only true to a limited extent for the vehicle 2, several trajectory pairs for the moment in time T₀ are determined by means of the method according to the invention.

The trajectory or driving path 3 of the vehicle 1 can be predicted quite precisely and reliably for several subsequent prediction periods Δt on the basis of the kinematic data that has been detected, such as speed, acceleration and direction. The relatively simple kinematic model can of course be complemented by a driver behaviour model.

On the basis of the behavioural model that is applied, the current position and the current state of motion of the pedestrian 2 are used to determine his/her first partial trajectory belonging to the first prediction period Δt, whereas the further incremental sequence of motion for the subsequent prediction periods Δt's is “guessed” by means of a random generator, wherein, however, only those movements that are allowed by the behavioural model are analyzed and a probability distribution on which the behavioural model is based is taken into account. For this purpose, sequences of motion or behavioural models of pedestrians can for example be taken into account by limiting the frequency distributions in a targeted manner when determining the further sequence of motion by means of a random generator.

The aforesaid method for computing the progressive trajectories is continued until the two trajectories of a trajectory pair would collide or cannot collide any more. For this purpose, it is assumed that there would be a collision if the pedestrian 2 has come so near to the vehicle 1 that a predefined minimum distance is no longer maintained during the relative motion of the two road users.

The probability of a collision is computed as a collision risk value obtained from the number of trajectory pairs which would indicate a collision and the total number of trajectory pairs that have been computed for the moment in time T₀. According to FIG. 1, 7 trajectory pairs were determined starting from a fixed moment in time T₀, wherein only one trajectory is shown as potential path of movement of the vehicle 1 for the sake of simplicity. At a moment in time T₀+Δt+ . . . +Δt+ . . . at which the vehicle has passed the pedestrian completely, five of said 7 trajectory pairs indicate a collision; therefore the collision risk value determined by computation is 5/7.

This collision risk value is initially valid for a predefined initial state according to FIG. 1 at the moment in time T₀. To determine the probability of a collision during the course of the scene according to FIG. 1 following the moment in time T₀, the computation explained above is repeated at time increments T₁, T₂, T₃ . . . , starting from the current positions and the current states of motion of the vehicle 1 and the pedestrian 2 in each case. In this way, a large number of potential future paths of movement in the form of a group of trajectory pairs are obtained for each of these moments in time T₁, T₂, T₃ . . . , which trajectory pairs always start from the current, actual traffic situation. Said group of trajectory pairs will then be the basis for the computation of the collision risk value for each of these moments in time T₁, T₂, T₃ . . . , and a chronological development of the collision risk values representing the probability of a collision will be obtained as a result.

This method according to the invention for determining the probability of a collision is a realistic and mathematically sound method, wherein a much broader prediction horizon is achieved, i.e. a long-term, yet reliable prediction is made.

This is in addition also achieved by the fact that the movement ability of the collision parties is taken into account when determining the probability of a collision, in particular the limited physiological movement ability of a living being, in particular a pedestrian. The behavioural model of a pedestrian thus takes into account both the physical movement options and the physiological movement ability.

In particular, the typical motion patterns or features indicating such typical motion patterns of a pedestrian are taken into account which can be characterized as indicators and can therefore be sensed in order to determine potential positions and finally the potential future position.

When analyzing the physiological movement ability, highly diverse states of motion as well as combinations of potential states of motion are taken into account.

For example, the maximum acceleration from a standstill position is taken into account without rotation, with a rotation over 90° and with a rotation over 180°. When considering the maximum acceleration ability of a pedestrian from a standstill position, it was found that said acceleration ability first increases from an initial value to a maximum value and then decreases more or less constantly as the speed of the pedestrian increases. For a rotation over 180°, it was found that the maximum acceleration ability is highly dependent on age on the one hand and differs widely, both up and down, around a statistical average. Compared to the acceleration ability from a standstill position, however, only small acceleration values can be reached here.

In an analogous manner, the maximum deceleration ability of a pedestrian walking at full speed is taken into account, both without a turn and with a maximum change in direction. Strong age-dependent differences were found here as well. The deceleration ability of a pedestrian walking at full speed without a change in direction exceeds the maximum acceleration ability of said pedestrian.

Another parameter that affects the potential position is the maximum acceleration when walking at a certain speed. The following typical cases are taken into account here: a 90° turn to the left and right and a 45° turn to the left and right. In this context, minimum possible curve radii of the pedestrian were determined. It was found that all pedestrians, irrespective of their age, were not able to move at a radius below a minimum curve radius. This information is valuable in order to estimate at which position a pedestrian can turn and move towards a road where a vehicle is approaching, and, if applicable, how much time it takes him/her to do so.

In an analogous manner, curve radii to the left and right were determined for a pedestrian walking at full speed.

To assess the physiological movement ability, a forward jump and a jump to the side were also taken into account. The times and distances that can be reached here can suitably be used to determine the ability, in particular of a pedestrian, to react in a sudden emergency.

FIG. 2 shows a diagram illustrating the acceleration and deceleration ability of a pedestrian as a function of his/her walking speed.

The term “current direction of movement/orientation” means that the pedestrian is assumed to move in accordance with the orientation of his/her body, i.e. in particular his/her trunk, wherein a non-moving pedestrian has no direction of movement, but certainly a particular orientation.

The positive acceleration ability in the current direction of movement/orientation is shown in quadrant Q1. Quadrant Q2 shows the negative acceleration ability, i.e. the ability to slow down, during forward movement, whereas quadrants Q3 and Q4 refer to a movement opposite to the orientation: Q3 describes the negative acceleration ability for this direction of movement, i.e. slowing down and, if applicable, accelerating in the normal direction again, while Q4 shows the acceleration ability during backward movement.

Referring to FIG. 2, the first decisive difference from conventional trajectory algorithms to be stated is that a defined acceleration ability, both in the direction of orientation and in the opposite direction, is specified even for a non-moving pedestrian.

As can be clearly seen in the diagram, the maximum acceleration ability aₘₐₓ and the maximum deceleration ability −aₘₐₓ do not correspond to an approximately equal speed v, but the acceleration ability starts to decrease early as the speed increases, whereas a considerably higher deceleration ability can be found even at higher speeds. The deceleration ability of a pedestrian exceeds in value his/her acceleration ability.

In addition, an acceleration ability opposite to the orientation is taken into account for the first time, although vehicles are also able to travel backwards, but this can still be taken into account in the trajectory, if applicable. If, however, the physiological movement ability is taken into account appropriately, FIG. 2 shows that the acceleration ability as well as the maximum speed opposite to the orientation clearly differ from those during normal forward movement.

If for example the following parameters for the pedestrian are specified for an algorithm:

a maximum speed from which the acceleration ability in the current direction of movement is zero,

a maximum acceleration in the direction of orientation of a non-moving pedestrian as well as opposite to said orientation,

a speed at which the maximum acceleration ability in the current direction of movement is highest,

a speed at which the maximum acceleration ability opposite to the current direction of movement and/or orientation of the pedestrian is highest in value,

a maximum speed opposite to the orientation of the pedestrian from which the acceleration ability opposite to said orientation is zero,

these parameters can be used to deduce the acceleration and deceleration abilities in each case in a relatively simple manner and with sufficient precision.

The aforesaid parameters are preferably predefined as a function of the class of pedestrian, in particular varying according to the age, gender, and body dimensions since there are significant differences here.

If just this interrelationship between the acceleration and speed of a pedestrian is taken into account, the potential position can be predicted and hence the probability of a collision can be determined much more precisely, compared to the state of the art.

In an analogous manner, FIG. 3 shows the ability to rotate about the own axis, wherein said rotation ability is normally symmetrical, but is clearly higher in the forward direction than during backward movement, while a decreasing though quite surprising rotation ability is maintained even at high speeds. Therefore, this parameter of the physiological movement ability also differs decisively from classical trajectory algorithms since these do not include a rotation about the own axis, let alone from a standstill position.

The physiological movement ability to the side, i.e. transversely to the orientation of the body and the normal walking direction, is in addition affected by the ability to step sideways. This ability to step sideways is significant in a standstill position and, even at a low speed of movement, results in the differences with regard to the maximum reachable area, a comparison of which is shown in the following FIGS. 3 and 4, but clearly decreases as the walking speed increases and can be omitted for normal forward movement if required and replaced with an increased rotation ability.

FIG. 4 shows a polar diagram which illustrates the range of motion of a non-moving pedestrian, taking into account his/her lateral and rotational acceleration ability and disregarding sideways and backward movements. The polar diagram covers angles ranging from 0° to 360°. An angle of 0° means that the pedestrian walks straight on. The polar diagram further includes concentric circles which are marked with 0.5, 1, 1.5, and 2. These are the distances (e.g. in metres) relative to the centre point where the human being is located at the moment in time t₀. At the moments in time t₁, t₂, t₃, t₄, t₅, the human being can be located within the ISO lines corresponding to said moments in time, wherein t₅>t₄>t₃>t₂>t₁.

Due to the physiological movement ability of the human being, he/she can move at a moment in time t₁ in an area which is enclosed by the corresponding ISO line. Essentially, a forward movement (i.e. in the walking direction, angle=0°) is possible here, while it is hardly possible to deviate from said 0° angle to the left (counter-clockwise) or to the right (clockwise). At a moment in time t₂ (t₂>t₁), the area widens in the forward direction as well as to the right and left (cf. the ISO line indicated by t₂). In an analogous manner, at a moment in time t₅ (t₅>t₄>t₃>t₂>t₁), the pedestrian can be located in the area enclosed by the corresponding ISO line. Here, not only a forward movement, but also a movement sideways towards the back is possible.

It will be apparent from the polar diagram that the physiological movement ability at the moments in time t₁ to t₅, which are in the future compared to t₀, will not allow movement in the angle range between 120° and 240°. This finding is important, e.g. if the pedestrian is positioned with his/her back to the road. The physiological range of motion only allows the pedestrian to move straight on (angle=0°), wherein short-term deviations are only possible in an angle range of less than ±90° and deviations of ±120° are only possible at a later moment in time (moment in time t₅). It can also be seen here that the distance which can be covered by the pedestrian becomes smaller as the angle increases. The illustration does not take into account that a pedestrian can also step backwards (angle=180°), but the distance which can be covered in this case is small.

If these sideways and backward forms of movement are included, once again a clear change in the movement area is obtained, as shown in FIG. 5. The result is an approximately elliptical pattern, wherein the centre of gravity of the ellipse is clearly displaced from the zero point in the direction of the normal orientation since the movement ability in the direction of orientation is higher than opposite to said orientation.

FIG. 6 shows a diagram illustrating the range of motion in the longitudinal direction sₗ and in the transverse direction s_{q} of a human being who moves at a speed v. It is assumed that the pedestrian is at the origin of the coordinates at a moment in time 0 and moves at a predefined speed in the longitudinal direction (i.e. along the x axis). At a moment in time t=0.4 s and taking into account all parameters, the pedestrian can be located in the hatched movement area marked with BAB1. At a moment in time t=0.6 s, the pedestrian can be located in the area marked with BAB2. In an analogous manner, the potential movement areas BAB3 at the moment in time t=0.8 s and BAB4 at the moment in time t=1 s are shown. It is apparent that the movement area widens, i.e. extends in the transverse direction s_{q}, on the one hand and has a greater depth on the other as time progresses. This is due to the fact that the potential options of the pedestrian in respect of his/her movement become more varied as time progresses, so that the potential movement area will also increase in size as a consequence.

FIG. 6 only shows movement areas BAB1, . . . , BAB4 in one transverse direction (to the left in the present exemplary embodiment). Of course, the movement area also extends in the other transverse direction, and the diagram shown in FIG. 6 must therefore be mirrored about the x axis.

FIG. 7 shows a flow chart which illustrates the method for determining the trajectory of a pedestrian. In a step S1, an ACTUAL position of a pedestrian is detected. This can e.g. be done by means of picture recording means in a vehicle. In a step S2, adverse effects on the position information (ST) are taken into account, which may e.g. be caused by measurement errors and the like. The clean data that has been determined in step S2 is used to determine a chronology, i.e. a history of movement of the pedestrian, in a step S3. It is e.g. sufficient if said history goes back 0.5 to 1 s into the past. This information serves to determine a movement trajectory on the one hand and a state of motion of the pedestrian on the other. The current state of motion of the pedestrian is determined in a step S5. In a step S6, the physical range of motion of the pedestrian is determined, taking into account the physiological movement ability of said pedestrian. This range of motion corresponds to the potential future movement area where the pedestrian can be located due to his/her orientation, walking speed, translational and/or rotational movement, his/her curve radius, his/her age, the ground friction coefficient, etc. Finally, a probability distribution of the range of motion or the movement area is determined in a step S7. Here, the movement area is divided into a number of different areas each having a probability that the pedestrian will be located there. The result is supplied to an evaluation unit AE. The current path of movement of the pedestrian, i.e. his/her movement trajectory, is determined in a step S6, which can be carried out parallel to step S5. The future path of movement of the pedestrian is determined in a step S7, taking into account restrictions caused by the surrounding conditions, and supplied to the evaluation unit AE. In parallel, typical motion patterns can be taken into account in a step S8. These may e.g. include findings as to how a pedestrian behaves at a traffic light or zebra crossing. This information is used in the attempt to determine an expected preferred direction of movement. Said information is also supplied to the evaluation unit AE, which uses the information supplied to determine a movement horizon of the pedestrian in a step S10. Said movement horizon once again corresponds to the movement area or the position.

This method enables a much more precise prediction of the probability of a certain position of a pedestrian or cyclist or an animal in the near future, based on a position measured over time.

This method and the method for determining the probability of a collision are for example jointly implemented in a control device, which uses the movement options of the vehicle and of the living being to compute a collision risk value indicating the probability of a collision, wherein the prediction quality is increased by taking into account the physiological movement ability of the living being.

As is apparent from the above description, a human being can decelerate much faster than accelerate, or cannot change direction or only make directional changes with small radii at higher walking speeds. This movement ability in addition differs according to individual circumstances, such as age, gender, fitness, etc, and is e.g. determined by means of tests before being implemented in an algorithm. The information can e.g. be stored in a memory and retrieved and used in accordance with the input data that has been determined in each case for a more precise determination of the probability of a certain position.

Moreover, characteristic motion patterns of living beings, in particular in typical traffic situations (e.g. at zebra crossings, traffic lights, etc.), can be determined by means of tests or traffic monitoring and taken into account in the method. Said motion patterns are compared with the movement of the living being that has been measured or determined, thus also increasing the prediction accuracy.

In addition, surroundings information can be taken into account, which can be supplied by navigation systems or digital maps. Moreover, a combination with state observers (a combination of digital maps with a surroundings sensing system) is possible. Restrictions of the movement options caused by obstacles (e.g. in the course of a road, house walls and the like) can be taken into account, thus also increasing the prediction accuracy. This can also be taken into account when predicting the future position of the vehicle.

To carry out these methods, a vehicle can be equipped with a suitable sensing system for detecting parameters of living beings or pedestrians, in particular those parameters defining their physiological movement ability, wherein a computing unit is designed to determine the potential future position or the progressive trajectory pairs at a given moment in time, based on a location of the movement trajectory and the state of motion and taking into account the physiological movement ability of the living being at one or several future moments in time. In particular to determine the trajectories of a pedestrian, relevant families of characteristics and physiological models can for example be stored, and the computing unit can then determine the probable position using the aforesaid parameters. In this way, a protection system for living beings or pedestrians outside the vehicle, in particular pedestrian protection devices, can be activated much more precisely, and false alarms can be much reduced.

Trajectory groups for a finite number of typical initial situations of motion for different types of pedestrians are predetermined and stored in the memory located aboard the vehicle during the initial phase, before the vehicle is put into operation, as illustrated in FIG. 8.

The trajectory groups are preferably determined once for each type of pedestrian for all potential initial situations of motion, and are stored with reference to the type of pedestrian concerned and the specific initial situation of motion.

A trajectory group for the pedestrians 100 of the group of “adult men” and the initial situation of motion BSi (vi, ai, wi) is determined as explained below. In the explanation, vi, ai and wi mean the initial speed, the initial acceleration and the initial rate of rotation respectively of the adult model man 100.

Based on this initial situation of motion BSi (vi, ai, wi), all potential typical movement trajectories ti1, . . . ti10 of the model pedestrian 100 are determined for a preferred period of time of 3 s at time increments of Δt=0.1 s. To provide a simplified illustration of the method according to the invention, the trajectory group is symbolized by just 10 trajectories in FIG. 8.

At the first measurement time t1, wherein t1=Δt=0.1 s, e.g. 10 position points or positions p10, . . . , p19 and the corresponding trajectories Ti1, . . . , Ti9 are determined. Since the pedestrian 100 is able to abruptly change his walking direction and walk in any direction, as discussed in the above description, the position points are in part located behind said pedestrian 100, i.e. in the direction opposite to the current orientation of the pedestrian 100 in the initial situation of motion (direction of the arrow). The position points p10, . . . , p19 jointly form a circle pk1, which will hereinafter be referred to as position circle. In fact, each point within this position circle is a potential position point of the pedestrian 100 at the moment in time t1. Since the pedestrian 100 has certain dimensions and a certain shape, such as e.g. width, depth, those position points that are close to each other are grouped and shown by just a few position points p10, . . . , p19, as illustrated in FIG. 8. The trajectories Ti1, . . . , Ti10 belonging to these position points p10, . . . , p19 jointly form a trajectory group for this type of pedestrians 100 and for their initial situation of motion BSi(vi, ai, wi). The number of trajectories in this trajectory group is 10.

Further position points p20, . . . , p29; p30, . . . , p39; p40, . . . , p49 for the trajectories Ti1, . . . , Ti10 that have already been detected are determined at subsequent moments in time t2=2*Δt=0.2 s, t3, t4.

To provide a simplified illustration of the method according to the invention, the trajectories are only taken into account for a period of time of 0.4 s here. Depending on the implementation, however, a period of time of approx. 3 s or more is taken into account.

The trajectory group TSi thus determined, which comprises 10 trajectories Ti1, . . . , Ti10 including the position points p10, . . . , p19; p20, . . . , p29; p30, . . . , p39; p40, . . . , p49, and the parameters of the initial situation of motion BSi(vi, ai, wi) are stored in a memory aboard the vehicle 200 with reference to the pedestrian group of “adult men” for later use.

Further initial situations of motion for other groups of pedestrians, such as adult women, elderly pedestrians, children, cyclists or animals such as dogs are defined, and relevant groups of movement trajectories are determined and stored aboard the vehicle 200.

During operation of the vehicle 200 or while driving through a city centre, first the pedestrians 100 in the proximity of the vehicle, in particular in the area or near the driving path 210 of the vehicle 200, are detected by means of the surroundings sensing system located aboard the vehicle 200, as illustrated in FIG. 9.

In addition, the states of motion of the detected pedestrians 100 are detected by means of suitable sensors, e.g. in the form of speed, acceleration and rate of rotation values v0, a0, w0. These states of motion are used as initial situations of motion BS0(v0, a0, w0) for the determination of the risk of a collision between the vehicle 200 and the pedestrian 100.

At the same time, the vehicle's 200 own dynamics, i.e. its speed, acceleration and/or rate of rotation, are detected. The travel of the vehicle is extrapolated at small time increments, based on the measured values relating to the vehicle's 200 own dynamics, thus obtaining a driving path 210, wherein said driving path comprises areas 221, 222, 223, 224 at respective time increments Δt or moments in time t1, t2, t3, t4. These areas 221, 222, 223, 224 are the collision zones at the time increments concerned. The time increments Δt correspond to the time increments used for computing the trajectory group of the pedestrian during the initial phase in FIG. 8.

If a pedestrian 100 is detected on the edge of the driving path 210, the state of motion values v0, a0, w0 of said pedestrian 100, which were measured directly by the surroundings sensing system located aboard the vehicle 200 or were measured by an inertial sensor carried by the pedestrian 100 and transmitted to the vehicle 200, are compared with the typical initial situation of motion values BS1(v1, a1, w1), Px-BS2(v2, a2, w2), . . . , BSi(vi, ai, wi), . . . , BSn(vn, an, wn) which were measured and stored during the initial phase.

Optionally, the type of pedestrian, i.e. the pedestrian group this pedestrian 100 should belong to, is determined using the data measured by the surroundings sensing system or the inertial sensor for this pedestrian 100 before the state of motion values are compared. If the data measured by the surroundings sensing system or the inertial sensor have characteristic features of an adult male pedestrian, the pedestrian 100 is categorized as belonging to the group of “adult men”.

If the newly detected pedestrian 100 is categorized as belonging to the group of “adult men”, only those initial situation of motion values BS1(v1, a1, w1), BS2(v2, a2, w2), . . . , BSi(vi, ai, wi), . . . , BSn(vn, an, wn) which were stored with reference to said group of “adult men” are retrieved and used for a comparison with the state of motion values v0, a0, w0.

If the state of motion values v0, a0, w0 of the pedestrian 100 are most similar to a set of initial situation of motion values, e.g. BSi(vi, ai, wi), the group of movement trajectories TSi which was stored with reference to this set of initial situation of motion values BSi(vi, ai, wi) is used to determine a collision.

This selected group of movement trajectories TSi belonging to these initial situation of motion values BSi(vi, ai, wi) is placed around the detected position of the pedestrian 100 in a suitable orientation, wherein said orientation preferably corresponds to the orientation of the pedestrian 100 relative to the direction of magnetic north (the direction of the arrow in FIG. 9), wherein the starting point of the group of movement trajectories TSi preferably overlaps the centre point of the pedestrian 100.

The position points p10, . . . , p19; p20, . . . , p29; p30, . . . , p39; p40, . . . , p49 of the trajectories Ti1, . . . , Ti10 of the selected trajectory group TSi are used to determine the risk of a collision at each of the aforesaid time increments Δt=0.1 s or at each moment in time t1, t2, t3, t4 in the analyzed time interval of 0.4 s, wherein the position points at the respective moments in time t1, t2, t3, t4 reflect the potential position points p10, . . . , p19; p20, . . . , p29; p30, . . . , p39; p40, . . . , p49 of the pedestrian 100 at the respective moments in time t1, t2, t3, t4.

Next, it will be checked how many of these position points p10, . . . , p19; p20, . . . , p29; p30, . . . , p39; p40, . . . , p49 are located within the relevant collision zone 221, 222, 223, 224 of the vehicle 200. Each of the position points which is located within the collision zone 221, 222, 223, 224 indicates a single collision between the vehicle 200 and the pedestrian 100. In FIG. 9, these are the position points p10 at the moment in time t1, p21, p29 at the moment in time t2, p23 at the moment in time t3.

The number of trajectories Ti1, Ti2, T3, Ti10 of the trajectory group including the position points which predict a single collision is determined. In the present embodiment, this number is 4. The trajectories Ti1, Ti2, T3, Ti10 including said collision position points are disregarded in the subsequent computation steps for the following time increments. For example, the trajectory Ti1 including the position point p10 which is located within the collision zone 221 at the moment in time t1 is disregarded when analyzing the following moments in time t2, t3, t4. Analogously, the trajectories Ti2, Ti10 whose position points p21, p29 are located within the collision zone 222 at the moment in time t2 are disregarded when analyzing the following moments in time t3, t4.

The position points which are located within the collision zone and the number of trajectories including these position points are continued to be determined at time increments of Δt until the vehicle 200 has passed the pedestrian 100 to an extent that no further collisions may occur.

Subsequently, the number of all (collision) trajectories where at least one position point is located within the collision zones is determined, and the quotient of the number of collision trajectories and the total number of trajectories is computed. This quotient indicates the probability of a collision. Said quotient can therefore be used to determine the risk of a collision.

In the present embodiment according to FIG. 9, this quotient is:

$$\begin{matrix}Q = \frac{Number of collision trajectories}{Number of trajectories} \\ = \frac{4 ( Ti 1 , Ti 2 , Ti 3 , Ti 10 )}{10 ( Ti 1 , … , Ti 10 )} \\ = 0.4 \\ = 40 \%\end{matrix}$$

Advantageously, the aforesaid quotient is compared with a number of predefined thresholds. If the quotient is below a first, lowest threshold, there is no risk of a collision. If the quotient exceeds the first threshold, but is still below a second, second-lowest threshold, there is a small risk of a collision. This small risk of a collision can e.g. be eliminated by means of an alarm signal to the driver of the vehicle. If, however, the quotient exceeds a last, highest threshold, there is an imminent risk of collision between the vehicle and the pedestrian. In this case, measures to reduce the consequences of the accident, e.g. autonomous full braking of the vehicle, are required.

In the present embodiment, the quotient has a value of 0.4, which indicates e.g. a relatively high risk of a collision. In this case, the vehicle transmits an acoustic signal to the driver and optionally also to the pedestrian, thus alerting the driver and the pedestrian to the imminent risk of a collision.

1. A method for determining the probability of a collision of a vehicle (1) with a living being (2), in which the behaviour in space and time of the living being (2) is modelled by means of a behavioural model and the behaviour in space and time of the vehicle (1) is modelled by means of a kinematic model and, starting from the current positions of the vehicle (1) and the living being (2), at least one trajectory (4) for each of them is determined, characterized in that
b) the current positions of the living being (2) and of the vehicle (1) are used to compute trajectories (3, 4) of the vehicle (1), based on the kinematic model, and of the living being (2), based on the behavioural model, as a trajectory pair until said trajectory pair either indicates a collision or indicates no collision,
c) the number of trajectory pairs indicating a collision is determined, and
d) the probability of a collision is determined as the quotient of the number of trajectory pairs indicating a collision and the total number of trajectory pairs that have been computed.

2. A method according to claim 1, characterized in that a collision is indicated if the distance between the vehicle (1) and the living being (2) which is indicated by the trajectories (3, 4) of a trajectory pair is below a predefined threshold.

3-30. (canceled)

31. The method according to claim 1, characterized in that the method steps b) to d) are repeated at time increments (T₁, T₂, T₃, . . . ).

32. The method according to claim 1, characterized in that the behavioral model is used to determine potential positions of the living being (2) for one or for several moments in time, taking into account the state of motion at the time when the computation of a trajectory pair starts.

33. The method according to claim 1, characterized in that the behavioral model takes into account the physical and physiological movement ability of the living being (2) and/or behavioral patterns of the living being (2) that have been determined empirically.

34. The method according to claim 33, characterized in that the behavioral model is used to determine potential positions of the living being (2) for one or for several moments in time, taking into account the state of motion at the time when the computation of a trajectory pair starts, and in that one or several of the following parameters are determined and processed as parameters for the determination of the state of motion and/or of the potential future position:
a rotational speed of the living being (2),
a rotational acceleration about a vertical axis of the living being (2),
a current radius of curvature of the movement of the living being (2),
a change in a direction of movement or of a radius of curvature of the movement of the living being (2),
an inertia of the living being (2),
a ground friction coefficient of the road surface, which in particular depends on the weather,
a class of the living being (2), in particular an age, a predefined body dimension (e.g. height, leg length or inside leg length), a gender or a category (e.g. human being/animal/child/cyclist),
an ability to move by means of one or several sideways steps,
an ability to move by means of one or several backward steps,
an ability to move by moving the center of gravity, and
an ability to move by inclining the body.

35. The method according to claim 34, characterized in that one or several of the following parameters are determined and processed as parameters for the determination of the state of motion and/or of the potential future position:
a position of the living being (2),
an orientation of the living being (2) relative to the surroundings,
a translational speed of the living being (2),
a translational acceleration of the living being (2),
the chronological development of at least one of the aforesaid parameters.

36. The method according to claim 34, characterized in that a potential future position of the living being (2) which has reference to the parameter(s) that has/have been determined or to the chronological development of at least one of the parameters that have been determined is retrieved or determined from a database or a family of characteristics or an analytical model.

37. The method according to claim 34, characterized in that one or several of the parameters are supplied to a model computer in order to determine a potential position of the living being (2), wherein said model computer is based on an abstract motion model for living beings (2).

38. The method according to claim 33, characterized in that a path of movement, which is dependent on the current speed, the current orientation and the current rotation of the body, is taken into account for the determination of the potential future position.

39. The method according to claim 33, characterized in that the maximum acceleration ability of the living being (2), which is dependent on his/her speed of movement, is taken into account for the determination of the potential future position.

40. The method according to claim 39, characterized in that dependent on the speed of movement of the living being (2) and in addition to a maximum acceleration ability in the current direction of movement, a maximum acceleration ability opposite to the current direction of movement and/or orientation of the living being (2) is predefined.

41. The method according to claim 40, characterized in that at least one of the following parameters is predefined for the living being (2):
a maximum speed from which the acceleration ability in the current direction of movement is zero,
a maximum acceleration in the direction of orientation of a non-moving living being (2) as well opposite to said orientation,
a speed at which the maximum acceleration ability in the current direction of movement is highest,
a speed at which the maximum acceleration ability opposite to the current direction of movement and/or orientation of the living being (2) is highest in value, a maximum speed opposite to the orientation of the living being (2) from which the acceleration ability opposite to said orientation is zero,
wherein these values are preferably predefined as a function of the class of living being (2) concerned, in particular varying according to age, gender and body dimensions.

42. The method according to claim 33, characterized in that a minimum possible curve radius, which is dependent on the current walking speed and/or acceleration, is taken into account for the determination of the potential future position.

43. The method according to claim 33, characterized in that a maximum deceleration ability, which is dependent on the speed of movement and/or a curve radius of the movement made by the living being (2), is taken into account for the determination of the potential future position.

44. The method according to claim 33, characterized in that an angle at which the living being (2) is positioned or moves relative to a path of travel of the vehicle (1) is taken into account for the determination of the potential future position, wherein said angle is used to determine the amount of time it takes the living being (2) to turn towards the path of travel while accelerating substantially at the same time in order to reach the travel path area.

45. The method according to claim 44, characterized in that the angle taken into account is an angle ranging between 150° and 210°, thus taking into account a living being (2) that is positioned or moves with his/her back to the path of travel.

46. The method according to claim 44, characterized in that the angle taken into account is an angle ranging between 60° and 120°, thus taking into account a living being (2) that is positioned or moves with his/her side to the path of travel.

47. The method according to claim 33, characterized in that the potential future position is determined taking into account a relative position of the living being (2) to a path of travel, in particular a distance at which the living being (2) is positioned or moves relative to said path of travel, wherein said relative position is used to determine the amount of time it takes the living being (2) a to speed up in order to reach the travel path area.

48. The method according to claim 33, characterized in that surroundings information and/or obstacles are taken into account for the determination of the potential future position.

49. The method according to claim 1, wherein before the vehicle (200) is put into operation, a finite number of typical initial situations of motion (BSi(vi, ai, wi)) for different types of pedestrians (100) are measured and stored in a memory which is located aboard the vehicle (200).

50. The method according to claim 49, wherein a group (TSi) of potential movement trajectories (Ti1, Ti2, . . . , Ti10) is computed for a predefined period of time comprising increments (Δt) for each of these initial situations of motion (BSi(vi, ai, wi)).

51. The method according to claim 50, wherein the initial situations of motion (BSi(vi, ai, wi)) and the trajectory groups (TSi) that have been computed are stored in the memory aboard the vehicle.

52. The method according to claim 51, wherein the risk of a collision is computed with the following method steps during operation of the vehicle:
the state of motion of the pedestrian (100) is detected using a suitable sensor system;
the nearest initial situation of motion (BSi(vi, ai, wi)) of the pedestrian (100), which was measured and stored in the memory before the vehicle (200) was put into operation, is selected; and
the trajectory group (TSi) which was computed for the selected initial situation of motion (BSi(vi, ai, wi)) before the vehicle (200) was put into operation and is stored with reference to said initial situation of motion (BSi(vi, ai, wi)) is retrieved and placed around the position of the pedestrian (100) that has been detected, in accordance with the orientation of said pedestrian (100).

53. The method according to claim 52, wherein the risk of a collision is further computed with the following method steps:
the travel of the vehicle is extrapolated at small time increments, thus obtaining a driving path (210), wherein said driving path (210) comprises collision zones (221, 222, 223, 224) at respective time increments (t1, t2, t3, t4);
at each time increment (t1, t2, t3, t4), only the position points (p10, . . . , p19; p20, . . . , p29; p30, . . . , p39; p40, . . . , p49) of the trajectories (Ti1, Ti2, . . . , Ti10) of the selected trajectory group (TSi) are analyzed, wherein said position points (p10, . . . , p19; p20, . . . , p29; p30, . . . , p39; p40, . . . , p49) at the respective time increment (t1, t2, t3, t4) reflect the potential positions of the pedestrian (100) at said time increment (t1, t2, t3, t4);
next, it is checked whether the selected position m points (p10, . . . , p19; p20, . . . , p29; p30, . . . , p39; p40, . . . , p49) are located within the collision zone (221, 222, 223, 224) of the vehicle (200); and
the number of trajectories (Ti1, Ti2, Ti3, Ti10) within the trajectory group (TSi) comprising the position points (p10, p21, p29, p32) which are located within one of the collision zones (221, 222, 223, 224) of the vehicle (200) and predict a single collision between the vehicle (200) and the pedestrian (100) is determined.

54. The method according to claim 53, wherein those trajectories (Ti1, Ti2, Ti3, Ti10) comprising the position points (p10, p21, p29, p32) which are located within one of the collision zones (221, 222, 223, 224) of the vehicle (200) and predict a single collision between the vehicle (200) and the pedestrian (100) are disregarded in the subsequent computation steps for the next time increments (t2, t3, t4).

55. The method according to claim 52, wherein the method steps are repeated at time increments (Δt) in order to determine the number of trajectories (Ti1, Ti2, Ti3, Ti10) comprising the position points (p10, p21, p29, p32) which are located within one of the collision zones (221, 222, 223, 224) of the vehicle (200) and predict a single collision between the vehicle (200) and the pedestrian (100) for the subsequent time increments (t2, t3, t4).

56. The method according to claim 52, wherein the method steps are continued to be carried out until the vehicle (200) has passed the pedestrian (100) to an extent that no further collisions between the vehicle (200) and the pedestrian (100) may occur.

57. The method according to claim 56, wherein the total number of trajectories (Ti1, Ti2, Ti3, Ti10) comprising at least one position point (p10, p21, p29, p32) which is located within one of the collision zones (221, 222, 223, 224) of the vehicle (200) is determined, and the quotient (Q) of the total number of collision trajectories (Ti1, Ti2, Ti3, Ti10) and the total number of trajectories (Ti1, . . . , Ti10) is computed.

58. A vehicle comprising a protection system for living beings (2) outside said vehicle (1), in particular pedestrian protection devices
comprising at least one sensing system to obtain surroundings information,
comprising a computing unit which evaluates said surroundings information in order to identify a living being, in particular a pedestrian (2), determines a movement trajectory for each of the living being (2) and the vehicle (1) as a trajectory pair, and uses said trajectory pair to deduce the probability of a collision and hence the necessity to activate a protection system, wherein
the sensing system is designed to detect parameters of living beings (2) and of their physiological movement ability, and
the computing unit is designed to determine the potential future position at a given moment in time, based on a location of the movement trajectory and on the state of motion and taking into account a physiological movement ability of the living being (2) for one or several future moments in time.
